(19) United States
(12) Patent Application Publication
(10) Pub. No.: US 2024/0343532 A1
(43) Pub. Date: Oct. 17, 2024

(54) AUTOMATIC AND MANUAL DISCONNECT FOR WIND ASSIST

(71) Applicant: Warn Industries, Inc., Clackamas, OR (US)

(72) Inventor: Eric VAUGHN, Milwaukie, OR (US)

(21) Appl. No.: 18/349,749

(22) Filed: Jul. 10, 2023

Related U.S. Application Data
(60) Provisional application No. 63/495,705, filed on Apr. 12, 2023.

(51) Int. Cl. B66D 1/58

(52) U.S. Cl. CPC B66D 1/58

(57) ABSTRACT

A disconnection device includes a shaft disposed within a housing and a base portion coupled to the housing. The base portion of the disconnection device, responsive to a force, laterally translates in relation to the housing when the force exceeds a predetermined threshold. The lateral translation of the base portion causes the shaft assembly to disengage a drive shaft.

### PRIORITY CLAIM AND CROSS-REFERENCE TO RELATED APPLICATIONS

This application claims priority to, and the benefit of, U.S. Provisional Patent App. No. 63/495,705, filed Apr. 12, 2023, entitled AUTOMATIC AND MANUAL DISCONNECT FOR WIND ASSIST, the entire contents of which are incorporated by reference herein and relied upon.

### FIELD

The present disclosure relates generally to systems for providing automatic and manual disconnect functions to wind assist winches.

### BACKGROUND

A fairlead, such as a hawse fairlead or roller fairlead, may be generally used to guide and restrict lateral movement of a rope or cable as the rope or cable is pulled through the fairlead and wound onto or off of a drum, such as a drum for a winch. Specifically, the rope or cable may extend through an opening in the fairlead and lateral movement of the rope or cable is constrained within the opening in the fairlead. Fairleads are typically used with winches, hoists, and other devices where a rope or cable is wound onto or off of a drum. For example, a fairlead may be mounted to a vehicle, in front of a winch, to guide the rope or cable of the winch as it is wound on and off of the winch drum.

As noted above, the fairlead constrains lateral movement of the rope or cable, for example, as it is wound onto the winch drum. As the rope or cable completes multiple revolutions around the winch drum, the rope or cable will “overlap” itself or, alternatively, lay next to itself. How neatly the rope or cable rests on the drum, as it is wound up, is dependent upon the angle of the rope relative to the drum. If this angle, also referred to as a fleet angle, is extreme relative to the winch drum, the rope or cable will not wind flatly and neatly onto the drum. Thus, fairleads may translate to improve the spooling of a rope or cable onto the drum. In a specific example, the fairlead is coupled to a drive rod, which rotates to laterally translate the fairlead and thus position the fairlead for proper spooling. However, it should be appreciated that during this spooling process, high tensile forces from the rope or cable may overload the fairlead or drive rod, causing damage to the system.

Improved systems for providing automatic and manual disconnect functions for overload protection are therefore needed.

### SUMMARY

The positioning systems disclosed herein improve on current winch technology by providing systems with automatic and manual disconnect functions.

In light of the disclosure, and without limiting the scope of the invention in any way, in a first aspect of the present disclosure, which may be combined with any other aspect listed herein unless specified otherwise, a disconnection device includes a shaft assembly disposed within a housing and a base portion coupled to the housing. Responsive to a force, the base portion is configured to laterally translate in relation to the housing, wherein the force exceeds a predetermined threshold, and wherein lateral translation of the base portion causes the shaft assembly to disengage a drive shaft.

In accordance with a second aspect of the present disclosure, which may be used in combination with any other aspect listed herein unless stated otherwise, the housing comprises a first housing portion removably coupled to a second housing portion.

In accordance with a third aspect of the present disclosure, which may be used in combination with any other aspect listed herein unless stated otherwise, the first housing portion and the second housing portion are removably coupled via a plurality of securing members.

In accordance with a fourth aspect of the present disclosure, which may be used in combination with any other aspect listed herein unless stated otherwise, the disconnection device includes a spring, wherein, responsive to the force, the base portion is configured to compress the spring and laterally translate in relation to the housing.

In accordance with a fifth aspect of the present disclosure, which may be used in combination with any other aspect listed herein unless stated otherwise, the shaft assembly includes a stationary cam, a translating cam, a shaft, and a half nut.

In accordance with a sixth aspect of the present disclosure, which may be used in combination with any other aspect listed herein unless stated otherwise, responsive to the force, the base portion is configured to rotate the translating cam of the shaft assembly.

In accordance with a seventh aspect of the present disclosure, which may be used in combination with any other aspect listed herein unless stated otherwise, the half nut disengages the drive shaft in response to the translating cam rotating.

In accordance with an eighth aspect of the present disclosure, which may be used in combination with any other aspect listed herein unless stated otherwise, the housing includes a first securing member, and wherein the first securing member extends through an elongated aperture of the base portion.

In accordance with a ninth aspect of the present disclosure, which may be used in combination with any other aspect listed herein unless stated otherwise, the elongated aperture of the base portion constrains the lateral translation of the base portion.

In accordance with a tenth aspect of the present disclosure, which may be used in combination with any other aspect listed herein unless stated otherwise, the elongated aperture is parallel to the drive shaft.

In accordance with an eleventh aspect of the present disclosure, which may be used in combination with any other aspect listed herein unless stated otherwise, a disconnection device includes a shaft assembly having a handle disposed within a housing. The handle is configured to rotate the shaft assembly, and the shaft assembly includes a first position and a second position based on a position of the handle.

In accordance with a twelfth aspect of the present disclosure, which may be used in combination with any other aspect listed herein unless stated otherwise, the housing comprises a first housing portion removably coupled to a second housing portion.

In accordance with a thirteenth aspect of the present disclosure, which may be used in combination with any other aspect listed herein unless stated otherwise, the first housing portion and the second housing portion are removably coupled via a plurality of securing members.

In accordance with a fourteenth aspect of the present disclosure, which may be used in combination with any other aspect listed herein unless stated otherwise, the shaft assembly engages a drive shaft in the first position, and the shaft assembly is disengaged from the drive shaft in the second position.

In accordance with a fifteenth aspect of the present disclosure, which may be used in combination with any other aspect listed herein unless stated otherwise, the shaft assembly translates in a first direction or a second direction based on the rotation of the handle.

In accordance with a sixteenth aspect of the present disclosure, which may be used in combination with any other aspect listed herein unless stated otherwise, the disconnection device further comprising a base portion coupled to the housing, wherein, responsive to a force, the base portion is configured to laterally translate in relation to the housing, wherein the force exceeds a predetermined threshold, and wherein lateral translation of the base portion causes the shaft assembly to disengage a drive shaft.

In accordance with a seventeenth aspect of the present disclosure, which may be used in combination with any other aspect listed herein unless stated otherwise, the disconnection device further comprising a spring, wherein, responsive to the force, the base portion is configured to compress the spring and laterally translate in relation to the housing.

In accordance with an eighteenth aspect of the present disclosure, which may be used in combination with any other aspect listed herein unless stated otherwise, the shaft assembly includes a first cam biased against a second cam.

In accordance with a nineteenth aspect of the present disclosure, which may be used in combination with any other aspect listed herein unless stated otherwise, the first cam is configured to rotate in response to the handle rotating, and wherein the first cam laterally translates away from the second cam, causing the shaft assembly to engage a drive shaft in the first position.

In accordance with a twentieth aspect of the present disclosure, which may be used in combination with any other aspect listed herein unless stated otherwise, the first cam is configured to rotate in response to the handle rotating, and wherein the first cam laterally translates toward the second cam, causing the shaft assembly to disengage a drive shaft in the second position.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been selected for readability and instructional purposes, and not to limit the scope of the inventive subject matter.

### BRIEF DESCRIPTION OF THE FIGURES

Understanding that figures depict only typical embodiments of the invention and are not to be considered to be limiting the scope of the present disclosure, the present disclosure is described and explained with additional specificity and detail through the use of the accompanying figures. The figures are listed below.

FIG. 1 illustrates a perspective view of a positioning system, according to an example embodiment of the present disclosure.

FIG. 2 illustrates a side view of a drive shaft housing, according to an example embodiment of the present disclosure.

FIG. 3 illustrates a disassembled view of a drive shaft housing, a shaft assembly, and a base portion, according to an example embodiment of the present disclosure.

FIG. 4 illustrates a bottom perspective view of a drive shaft housing and a base portion, according to an example embodiment of the present disclosure.

FIG. 5 illustrates a cross-sectional view of a drive shaft housing, a shaft assembly, and a base portion, according to an example embodiment of the present disclosure.

FIGS. 6A to 6D illustrate several views of a drive shaft housing, according to an example embodiment of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specifies the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

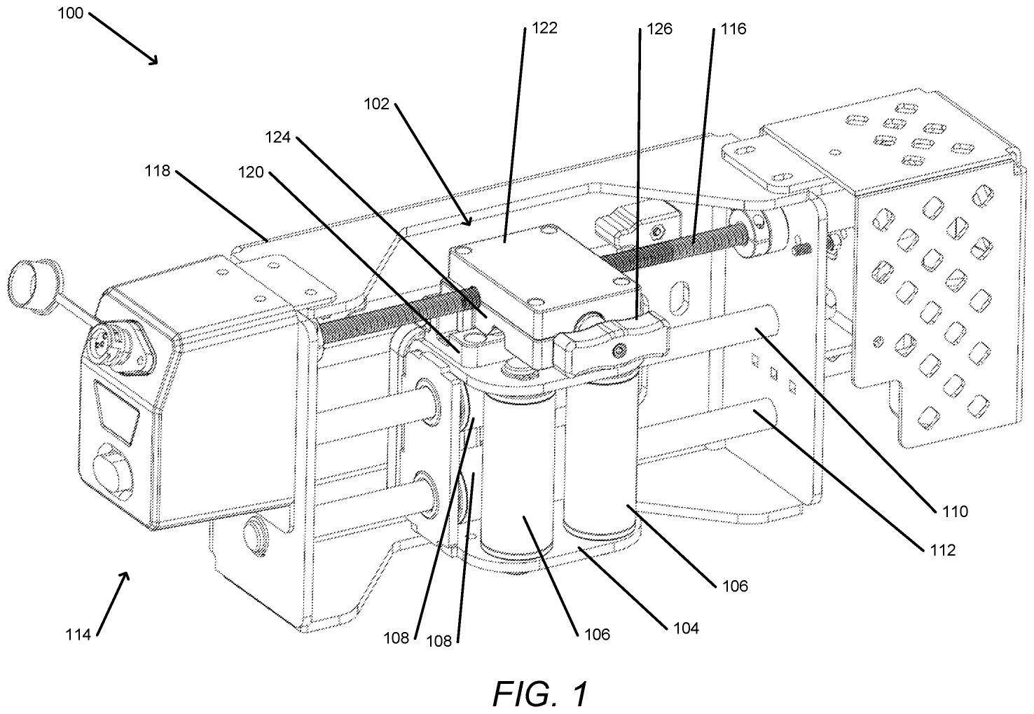

FIG. 1 illustrates a perspective view of a positioning system 100, according to an example embodiment of the present disclosure. The positioning system 100 includes a drive shaft housing 102 coupled to a base portion 120 disposed on a frame 104. The frame 104 includes a first set of rollers 106 and a second set of rollers 108. As illustrated by FIG. 1, the first set of rollers 106 is oriented vertically within the frame 104, and the second set of rollers 108 is oriented horizontally within the frame 104. It should be appreciated that, in other embodiments, the first set of rollers 106 could be oriented horizontally and the second set of rollers 108 could be oriented vertically. Likewise, in other embodiments, the positioning system 100 may include fewer, or more, than two sets of rollers.

In an example embodiment, the first set of rollers 106 and the second set of rollers 108 may be the same and/or similar size and shape. The first set of rollers 106 and the second set of rollers 108 may each include a substantially cylindrical shape and attach to the frame 104 in a manner allowing rolling movement along an axis parallel to the length of each roller. As illustrated in FIG. 1, the first set of rollers 106 is positioned vertically relative to the front of the positioning system 100 as to create a front-facing surface of the frame 104, but allow for a rope or a cable to pass between the first set of rollers 106. The second set of rollers 108 is positioned horizontally and perpendicular to the first set of rollers 106, immediately adjacent the first set of rollers 106. Thus, in an example, the first set of rollers 106 and the second set of rollers 108 may be positioned in a manner to create an aperture that allows a rope or a cable to pass between both the first set of rollers 106 and the second set of rollers 108.

In this way, the frame 104, along with the first set of rollers 106 and the second set of rollers 108, can be characterized generally as a roller fairlead (given that a rope or a cable passes “through” these roller components). As disclosed herein, the positioning system 100 translates this roller fairlead laterally, as controlled by a motor 114 communicating with multiple sensors, to ensure that the rope or the cable has the proper fleet angle with a winch drum; this ensures that the rope or the cable winds appropriately. Lateral translation of the fairlead is controlled via separate means (e.g., a motor, separate and distinct from the winch and winch motor), such that the disclosed positioning system 100 can be implemented with existing winching systems. Furthermore, while the fairlead disclosed in many embodiments herein is a roller fairlead, it should be appreciated that other fairleads are, likewise, contemplated. Namely, in an alternative embodiment, the frame 104 does not include the first set of rollers 106 nor the second set of rollers 108, yet, nonetheless, laterally translates; in this embodiment, the frame 104 can be characterized generally as a hawse fairlead (given that a rope or cable passes “through” this component).

The positioning system 100 further includes a first guide rod 110, a second guide rod 112, and a drive shaft 116. The first guide rod 110, the second guide rod 112, and the drive shaft 116 are disposed within a housing 118 of the positioning system 100. As illustrated in FIG. 1, the first guide rod 110 and the second guide rod 112 are disposed laterally within the housing 118. The first guide rod 110 and the second guide rod 112 permit lateral movement of the frame 104 along the length of the first guide rod 110 and the second guide rod 112 in either horizontal direction. However, the housing 118 constrains this lateral movement of the frame 104 along the first guide rod 110 and the second guide rod 112. In FIG. 1, the second set of rollers 108 is disposed concentrically onto the first guide rod 110 and the second guide rod 112, respectively, such that the second set of rollers 108, likewise, is permitted to move laterally within housing 118. In alternate embodiments, it should be appreciated that second set of rollers 108 is disposed independent of guide rods 110, 112.

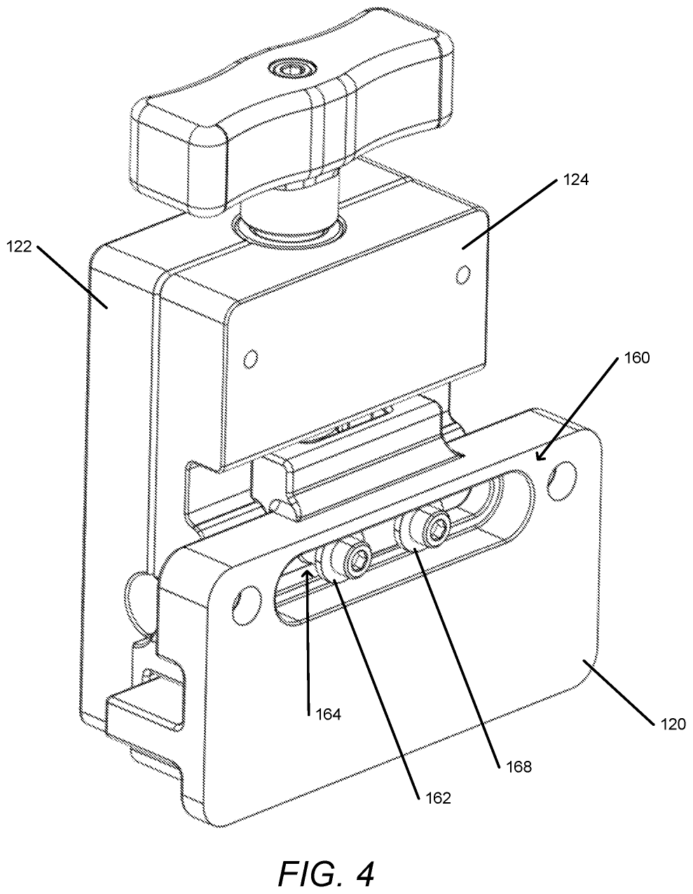

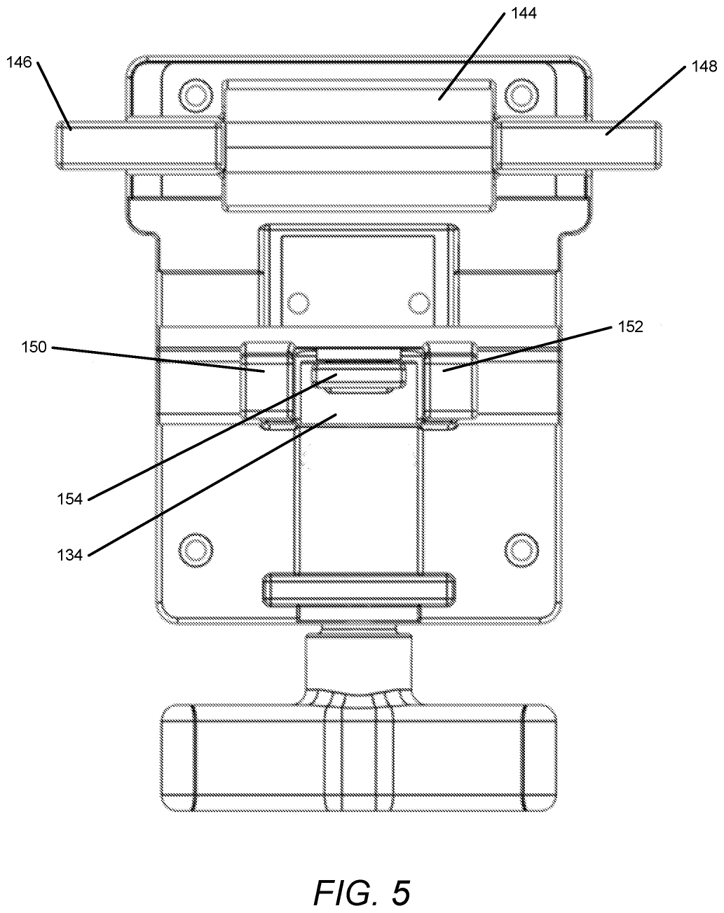

As introduced above, the positioning system 100 includes a drive shaft housing 102 coupled to the base portion 120 disposed on the frame 104. Namely, the drive shaft 116 extends through the drive shaft housing 102, and the drive shaft housing 102 is coupled to the base portion 120, which is disposed on the frame 104. Thus, the drive shaft housing 102, the base portion 120, and the frame 104 generally translate within the housing 118 along the first guide rod 110 and the second guide rod 112 as described above. The relationship between the drive shaft housing 102 and the base portion 120 is further described in reference to FIG. 4 and FIG. 5.

In an embodiment, positioning system 100 is driven by the motor 114 and the drive shaft 116. In this embodiment of FIG. 1, the drive shaft 116 is connected to the motor 114 and passes horizontally through the drive shaft housing 102. For example, when the drive shaft 116 is a spiraled lead screw with threading, and the drive shaft housing 102 includes an internal half nut with complementary threading, the drive shaft housing 102 is threaded onto the spiraled lead screw. Thus, rotation of the drive shaft 116 by the motor 114 causes lateral translation of the drive shaft housing 102, thereby laterally translating the frame 104 within the housing 118. In this way, as the motor 114 rotates the drive shaft 116, the rotation of the drive shaft 116 causes the frame 104 to translate laterally along the first guide rod 110 and the second guide rod 112 within the housing 118. As the frame 104 moves laterally along the first guide rod 110 and the second guide rod 112, a rope or cable passing through the frame 104 also moves laterally with the frame 104. In this configuration, the drive shaft housing 102 is in a first, or engaged position. In the first, or engaged, position, the drive shaft housing 102 only lateral translates within the housing 118 when the drive shaft 116 rotates. Thus, the drive shaft housing 102 is engaged with the drive shaft 116.

The drive shaft housing 102 includes a first housing portion 122 and a second housing portion 124. A shaft assembly (not shown in FIG. 1) is disposed within the drive shaft housing 102 between the first housing portion 122 and the second housing portion 124. The shaft assembly includes a handle 126 that provides a manual disconnect function. The handle 126 includes a first position and a second position. In FIG. 1, the handle 126 is parallel to the first guide rod 110 and the second guide rod 112, which corresponds to a first, or engaged, position. As described above, in the engaged position, the shaft assembly within the drive shaft housing 102 engages the drive shaft 116. Thus, rotation of the drive shaft 116 causes lateral translation of the drive shaft housing 102, thereby causing lateral translation of the frame 104.

Alternatively, a user may rotate the handle approximately 90 degrees in either direction, which corresponds to the second, or disengaged, position. When the handle is in the disengaged position, the shaft assembly within the drive shaft housing 102 does not engage the drive shaft 116. In the disengaged position, rotation of the drive shaft 116 will not cause lateral translation of the drive shaft housing 102 because the shaft assembly is not engaged with the drive shaft 116. Instead, a user can freely slide the drive shaft housing 102 with the base portion 120 and the frame 104 laterally along the first guide rod 110 and the second guide rod 112 within the bounds of the housing 118. It should be appreciated that, in other embodiments, the orientation and corresponding position of the handle could be varied. For example, the handle 126 may be generally parallel to the drive shaft 116 in the disengaged position, and the handle 126 may be generally perpendicular to the drive shaft 116 in the engaged position.

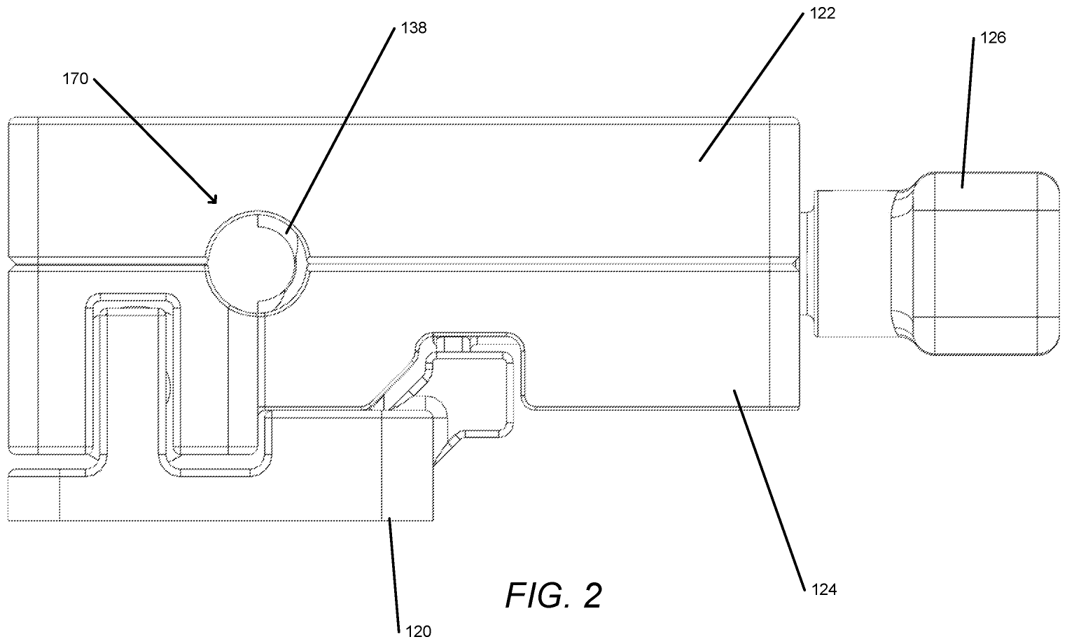

FIG. 2 illustrates a side view of a drive shaft housing, according to an example embodiment of the present disclosure. As introduced in reference to FIG. 1, the drive shaft housing 102 includes the first housing portion 122, the second housing portion 124, and the handle 126. The first housing portion 122 is removably coupled to the second housing portion 124, and the second housing portion 124 is coupled to the base portion 120. As shown in FIG. 1, the base portion 120 is coupled to the frame 104. In an example embodiment, a plurality of screws, or securing members, extend through the first housing portion 122 to mate with a plurality of threaded apertures in the second housing portion 124. When the first housing portion 122 and the second housing portion 124 are coupled together, a drive shaft aperture 170 is formed. In reference to FIG. 1, the drive shaft 116 extends through the drive shaft aperture 170 of the drive shaft housing 102. In the engaged position, a half nut 138 of the shaft assembly engages the drive shaft 116. In the disengaged position, the half nut 138 of the shaft assembly does not engage the drive shaft 116.

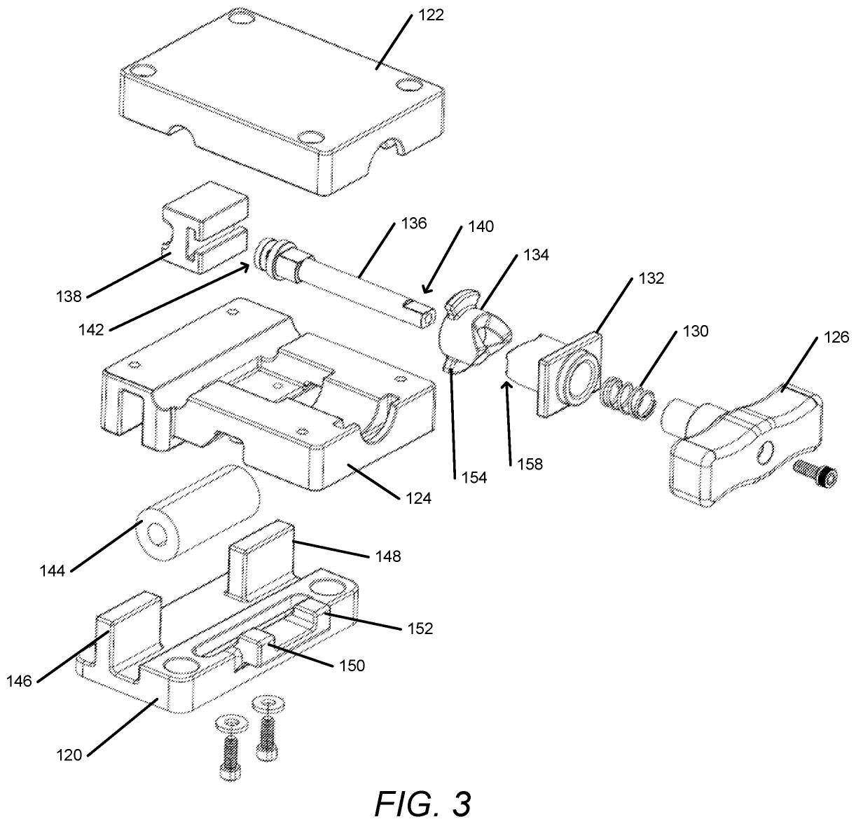

FIG. 3 illustrates a disassembled view of a drive shaft housing, a shaft assembly, and a base portion, according to an example embodiment of the present disclosure. The shaft assembly 128 includes the handle 126, a spring 130, a stationary cam 132, a translating cam 134, a shaft 136, and the half nut 138. The handle 126 is coupled to a first end 140 of the shaft 136, which extends through the stationary cam 132 and extends through the translating cam 134. A second end 142 of the shaft 136 is coupled to the half nut 138. The spring 130 is configured to bias the stationary cam 132 against the translating cam 134. The stationary cam 132 is fixed from moving relative to the drive shaft housing 102 while the translating cam 134 is fix from moving relative to the shaft 136 of the shaft assembly 128.

As described above, the handle 126 includes an engaged position and a disengaged position, thereby providing a manual disconnect feature. In an example, the handle 126, as shown in FIG. 3, is in a first, or engaged position. In the engaged position, the shaft assembly 128 engages the drive shaft (not shown in FIG. 2) via the half nut 138. A user may rotate the handle 126 approximately 90 degrees, retracting the half nut 138 from the drive shaft causing the shaft assembly 128 to transition from the first, or engaged, position to a second, or disengaged position.

In an illustrative process, the user rotates the handle 126 approximately 90 degrees retracting the half nut 138 from the drive shaft. Namely, in response to the handle 126 rotating, the shaft 136 rotates, which rotates the translating cam 134. The bias force of the spring 130 against the stationary cam 132 causes the translating cam 134 to translate toward the stationary cam 132, thereby retracting the half nut 138 from the drive shaft 116 to disengage the drive shaft 116.

Similarly, a user may again rotate the handle 126 approximately 90 degrees extending the half nut 138 against the drive shaft. Namely, in response to the handle 126 rotating, the shaft 136 rotates, which rotates the translating cam 134. The rotation of the translating cam 134 causes the translating came to overcome the bias force of the spring 130 against the stationary cam 132. This causes the translating cam 134 to translate away from the stationary cam 132, thereby extending the half nut 138 against the drive shaft 116 to engage the drive shaft 116.

Besides the manual disconnect feature provided by the handle 126, the positioning system 100 also provides an automatic disconnect feature. In reference to FIG. 3, the base portion 120 interacts with a spring 144 and the shaft assembly 128. The shaft assembly 128 is disposed between the first housing portion 122 and the second housing portion 124, and the spring 144 is disposed between the base portion 120 and the second housing portion 124.

The base portion 120 includes a first spring strike plate 146, a second spring strike plate 148, a first cam strike plate 150, and a second cam strike plate 152. In reference to FIG. 1, a rope or a cable may pass between the first set of rollers 108. The first set of rollers 108 constrains lateral movement of the rope or the cable as it is wound onto a winch drum. In an example, the rope or the cable passes between the first set of rollers 108 and extends to the right in relation to the positioning system 100. When the rope or the cable is wound onto the winch drum, high tensile forces from the rope or the cable may be loaded onto the frame 104 in a direction from left to right. As the base portion 120 is fixed to the frame 104, the side load will, in this example, force the base portion 120 from left to right.

Turning back to FIG. 3, the side load is translated from the frame 104 to the base portion 120 and further transferred to the spring 144 via the first spring strike plate 146. When the side load is above a predetermined threshold force, the base portion 120 overcomes the force of the spring 144 to translate laterally in relation to the drive shaft housing 102. This lateral translation causes the first cam strike plate 150 to translate toward a first extension 154 of the translating cam 134. If the base portion 120 and the first cam strike plate 150 laterally translate above a predetermined threshold distance, the first cam strike plate 150 contacts the first extension 154 of the translating cam 134. When the first cam strike plate 150 contacts the first extension 154 of the translating cam 134 and continues to laterally translate, the translating cam 134 begins to rotate. Once the translating cam 134 rotates sufficiently to overcome a notch 158 in the stationary cam 132, the translating cam 134 translates toward the stationary cam 132 due to the force of the spring 130. As the translating cam 134 translates toward the stationary cam 132, the shaft 136 and the half nut 138 retract away from the drive shaft 116 disengaging the drive shaft 116, similar to the manual disconnect function.

Since the shaft assembly 128 is ambidextrous, this automatic disconnect feature may be activated whether the frame 104 is side loaded from the left or right. Thus, the above description would function the same with the second spring strike plate 148 and second cam strike plate 152 in a side load forcing the base portion 120 from right to left. After an automatic breakaway occurs, the drive shaft housing 102 is now in the disengaged position. In the disengaged position, the user can reengage the shaft assembly 128 with the drive shaft 116 by turning the handle 90 degrees in either direction as described above in reference to the manual disconnect function. Automatic disconnection protects drive shaft 116 (and other related mechanical components) from excessive side loads by triggering disengagement once the threshold is met.

FIG. 4 illustrates a bottom perspective view of a drive shaft housing and a base portion, according to an example embodiment of the present disclosure. FIG. 4 illustrates the first housing portion 122, the second housing portion 124, and the base portion 120. The second housing portion 124 is coupled to the base portion 120 such that the base portion 120 can laterally translate in relation to the first housing portion 122, the second housing portion 124, and the shaft assembly disposed therein.

The base portion 120 includes an elongated aperture 160. The elongated aperture 160 is parallel to the first guide rod and the second guide rod, allowing the base portion 120 to laterally translate in relation to the first housing portion 122 and the second housing portion 124 along the first guide rod and the second guide rod. The second housing portion 124 includes a first securing member 164 having a first cap 162 and a second securing member (not shown) having a second cap 168. The first securing member 164 and the second securing member are configured to extend through the elongated aperture 160 while the first cap 162 and the second cap 168 secure the second housing portion 124 to the base portion 120. In such configuration, the base portion 120 may laterally translate to the extent permitted by the first securing member 164 and the second securing member within the elongated aperture 160. In reference to FIG. 1, a side load acts on the frame 104. This side load is translated to the base portion 120. If the force is above a predetermined threshold, the base portion 120 laterally translates while the drive shaft housing 102 remains stationary.

FIG. 5 illustrates a cross-sectional view of a drive shaft housing, a shaft assembly, and a base portion, according to an example embodiment of the present disclosure. FIG. 5 illustrates the spring 144, which is disposed between the first spring strike plate 146 of the base portion 120 and the second spring strike plate 148 of the base portion 120. Further, the first extension 154 of the translating cam 134 is disposed between the first cam strike plate 150 of the base portion 120 and the second cam strike plate 152 of the base portion 120.

In an example of lateral translation, a force acts on the base portion 120 from left to right. In response, the first spring strike plate 146 loads the spring 144 from left to right. If the force is greater than the spring constant, the spring 144 begins to compress against the first housing portion 122. As the spring 144 compresses, the base portion 120 laterally translates, causing the first cam strike plate 150 to contact and rotate the first extension 154 of the translating cam 134. Again, as described above, with sufficient rotation, the translating cam 134 overcomes the detent and translates toward the stationary cam to retract the half nut against the drive shaft. In various embodiments, the spring 144 can be altered to correspond to a desired spring constant. Based on the spring constant, the force required to translate the base portion 120 and trigger the automatic disconnect feature can be determined.

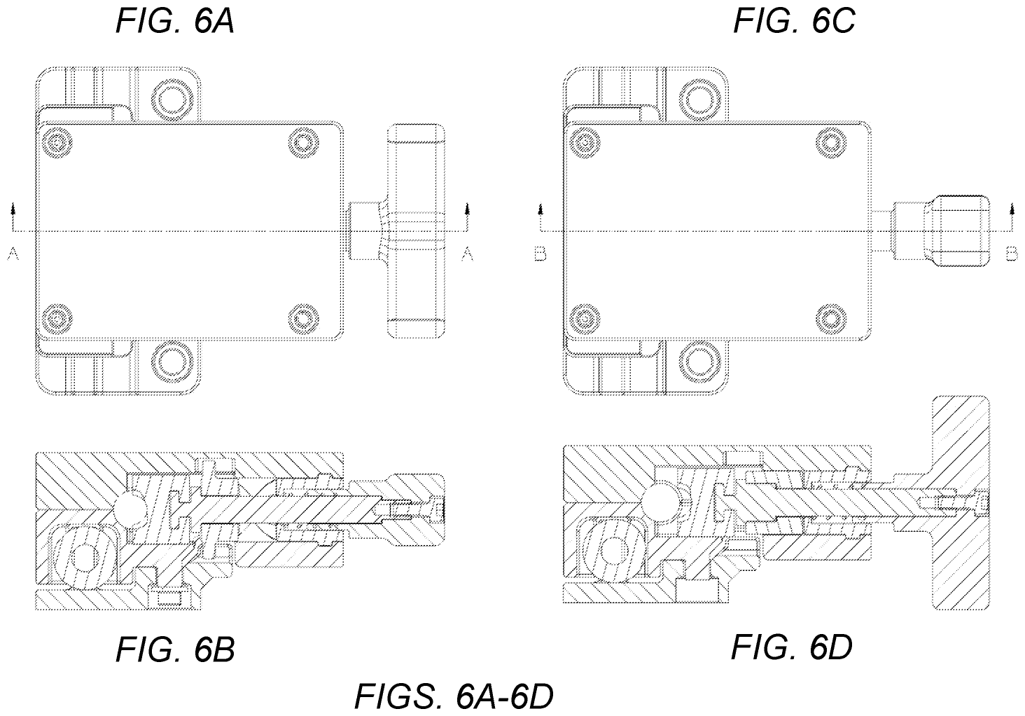

FIGS. 6A to 6D illustrate several views of a drive shaft housing, according to an example embodiment of the present disclosure. Namely, FIG. 6A illustrates a top view of the drive shaft housing 102 in the engaged position, and FIG. 6B illustrates a cross-sectional view of the drive shaft housing 102 in the engaged position. As shown in FIGS. 6A and 6B, the handle 126 is parallel to the drive shaft. Similarly, FIG. 6C illustrates a top view of the drive shaft housing 102 in the disengaged position, and FIG. 6D illustrates a cross-sectional view of the drive shaft housing 102 in the disengaged position. As shown in FIGS. 6C and 6D, the handle 126 is approximately perpendicular to the drive shaft.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A disconnection device, comprising:
a shaft assembly disposed within a housing; and
a base portion coupled to the housing,
wherein, responsive to a force, the base portion is configured to laterally translate in relation to the housing, wherein the force exceeds a predetermined threshold, and wherein lateral translation of the base portion causes the shaft assembly to disengage a drive shaft.

2. The disconnection device of claim 1, wherein the housing comprises a first housing portion removably coupled to a second housing portion.

3. The disconnection device of claim 2, wherein the first housing portion and the second housing portion are removably coupled via a plurality of securing members.

4. The disconnection device of claim 1 further comprising a spring, wherein, responsive to the force, the base portion is configured to compress the spring and laterally translate in relation to the housing.

5. The disconnection device of claim 1, wherein the shaft assembly comprises:
a stationary cam;
a translating cam;
a shaft; and
a half nut.

6. The disconnection device of claim 5, wherein, responsive to the force, the base portion is configured to rotate the translating cam of the shaft assembly.

7. The disconnection device of claim 6, wherein the half nut disengages the drive shaft in response to the translating cam rotating.

8. The disconnection device of claim 1, wherein the housing includes a first securing member, and wherein the first securing member extends through an elongated aperture of the base portion.

9. The disconnection device of claim 8, wherein the elongated aperture of the base portion constrains the lateral translation of the base portion.

10. The disconnection device of claim 8, wherein the elongated aperture is parallel to the drive shaft.

11. A disconnection device, comprising:
a shaft assembly having a handle,
wherein the shaft assembly is disposed within a housing, and wherein the handle is configured to rotate the shaft assembly, and
wherein the shaft assembly comprises a first position and a second position based on a position of the handle.

12. The disconnection device of claim 11, wherein the housing comprises a first housing portion removably coupled to a second housing portion.

13. The disconnection device of claim 12, wherein the first housing portion and the second housing portion are removably coupled via a plurality of securing members.

14. The disconnection device of claim 11, wherein the shaft assembly engages a drive shaft in the first position, and wherein the shaft assembly is disengaged from the drive shaft in the second position.

15. The disconnection device of claim 11, wherein the shaft assembly translates in a first direction or a second direction based on the rotation of the handle.

16. The disconnection device of claim 11 further comprising a base portion coupled to the housing, wherein, responsive to a force, the base portion is configured to laterally translate in relation to the housing, wherein the force exceeds a predetermined threshold, and wherein lateral translation of the base portion causes the shaft assembly to disengage a drive shaft.

17. The disconnection device of claim 16 further comprising a spring, wherein, responsive to the force, the base portion is configured to compress the spring and laterally translate in relation to the housing.

18. The disconnection device of claim 11, wherein the shaft assembly includes a first cam biased against a second cam.

19. The disconnection device of claim 18, wherein the first cam is configured to rotate in response to the handle rotating, and wherein the first cam laterally translates away from the second cam, causing the shaft assembly to engage a drive shaft in the first position.

20. The disconnection device of claim 18, wherein the first cam is configured to rotate in response to the handle rotating, and wherein the first cam laterally translates toward the second cam, causing the shaft assembly to disengage a drive shaft in the second position.
